(19) United States
(12) Patent Application Publication
(10) Pub. No.: US 2022/0070362 A1
(43) Pub. Date: Mar. 3, 2022

(54) CONTROL APPARATUSES, PHOTOGRAPHING APPARATUSES, MOVABLE OBJECTS, CONTROL METHODS, AND PROGRAMS

(71) Applicant: SZ DJI TECHNOLOGY CO., LTD., Shenzhen (CN)

(72) Inventors: Yoshinori NAGAYAMA, Shenzhen (CN); Kenichi HONJO, Shenzhen (CN); Norie SEKI, Shenzhen (CN)

(73) Assignee: SZ DJI TECHNOLOGY CO., LTD., Shenzhen (CN)

(21) Appl. No.: 17/524,637

(22) Filed: Nov. 11, 2021

Related U.S. Application Data
(63) Continuation of application No. PCT/CN2020/106737, filed on Aug. 4, 2020.

(30) Foreign Application Priority Data
Aug. 20, 2019 (JP) 2019-150644

(51) Int. Cl. H04N 5/232; G06T 7/70

(52) U.S. Cl. CPC H04N 5/23218; G06T 7/70; H04N 5/23299; H04N 5/23212

(57) ABSTRACT

A control apparatus for controlling a photographing system, the photographing system includes: a ranging sensor to measure distances of each to-be-photographed objects associated with each of a plurality of regions, the plurality of to-be-photographed objects include a first target object, the first target object is associated with a first region and a first distance; and a photographing apparatus. The control apparatus is configured to: cause the photographing apparatus to perform focus control on the first target object based on the first distance, control the photographing apparatus to obtain a plurality of images, determine, based on the plurality of images, whether a second target object is in the first region, the second target object being a moving object in the first region; and cause the photographing apparatus to perform different focus controls on the first region based on whether or not the second target object is present in the first region.

### RELATED APPLICATIONS

This application is a continuation application of PCT application No. PCT/CN2020/106737, filed on Aug. 4, 2020, which claims priority of Japanese application No. JP2019-150644, filed on Aug. 20, 2019, and the contents of both applications are incorporated herein by reference in their entirety.

### TECHNICAL FIELD

The present disclosure relates to a control apparatus, a photographing system, a control method, and a program.

### BACKGROUND

As described in Reference 1, a distance to a target object is measured according to reflective light of an optical pulse.

### PRIOR ART LITERATURE

Reference 1: Japanese Patent Publication No. 2006-79074.

### BRIEF SUMMARY

Technical problem to be resolved:

In a photographing apparatus that performs focus control according to a distance measured by a ranging sensor, it is sometimes challenging to perform focus control properly when a non-primary to-be-photographed object passes in front of a primary to-be-photographed object.

Some exemplary embodiments of the present disclosure provide a control apparatus for controlling a photographing system, where the photographing system includes: a ranging sensor to measure distances of each to-be-photographed objects associated with each of a plurality of regions, where the plurality of to-be-photographed objects include a first target object, the first target object is associated with a first region and a first distance; and a photographing apparatus to perform focus control based on the distances; the control apparatus including: a circuit configured to: cause the photographing apparatus to perform focus control on the first target object based on the first distance, control the photographing apparatus to obtain a plurality of images, determine, based on the plurality of images, whether a second target object is in the first region, the second target object being a moving object in the first region; and cause the photographing apparatus to perform different focus controls on the first region based on whether or not the second target object is present in the first region.

Some exemplary embodiments of the present disclosure provide a photographing system, including: a ranging sensor to measure distances of each to-be-photographed objects associated with each of a plurality of regions, where the plurality of to-be-photographed objects include a first target object, the first target object is associated with a first region and a first distance; a photographing apparatus to perform focus control based on the distances; and a control apparatus, including: a circuit configured to: cause the photographing apparatus to perform focus control on the first target object based on the first distance, control the photographing apparatus to obtain a plurality of images, and determine, based on the plurality of images, whether a second target object is in the first region, the second target object being a moving object in the first region; and cause the photographing apparatus to perform different focus controls on the first region based on whether or not the second target object is present in the first region.

Some exemplary embodiments of the present disclosure provide a method for controlling a photographing system, where the photographing system includes: a ranging sensor to measure distances of each to-be-photographed objects associated with each of a plurality of regions, where the plurality of to-be-photographed objects include a first target object, the first target object is associated with a first region and a first distance; and a photographing apparatus to perform focus control based on the distances, where the control method includes: causing the photographing apparatus to perform focus control on the first target object based on the first distance, controlling the photographing apparatus to obtain a plurality of images, determining, based on the plurality of images, whether a second target object is in the first region, the second target object being a moving object in the first region, and causing the photographing apparatus to perform different focus controls on the first region based on whether or not the second target object is present in the first region.

In addition, not all necessary features of the present disclosure have been exhausted in the foregoing contents. In addition, sub-combinations of these feature groups may also be covered under the present disclosure.

### BRIEF DESCRIPTION OF THE DRAWINGS

To clearly describe the technical solutions in the embodiments of the present disclosure, the following briefly describes the accompanying drawings required for describing the embodiments. Evidently, the accompanying drawings in the following description show merely some exemplary embodiments of the present disclosure, and a person of ordinary skill in the art may still derive other drawings from these accompanying drawings without creative efforts.

FIG. 1 is a perspective view of a photographing system according to some exemplary embodiments of the present disclosure;

FIG. 2 is a perspective view of a photographing system according to some exemplary embodiments of the present disclosure;

FIG. 3 is a functional block diagram of a photographing system according to some exemplary embodiments of the present disclosure;

FIG. 4 is a schematic diagram showing color distribution and optical flow when a non-primary to-be-photographed object crosses in front of a primary to-be-photographed object according to some exemplary embodiments of the present disclosure;

FIG. 5 is a diagram showing a relationship between a viewing angle of a photographing apparatus and a viewing angle of a TOF sensor according to some exemplary embodiments of the present disclosure;

FIG. 6 is a diagram showing a relationship between a viewing angle of a photographing apparatus and a viewing angle of a TOF sensor according to some exemplary embodiments of the present disclosure;

FIG. 7A is a flow chart of a focus control performed by using a photographing system according to some exemplary embodiments of the present disclosure;

FIG. 7B is a flow chart of a focus control performed by using a photographing system according to some exemplary embodiments of the present disclosure;

FIG. 8 is a diagram showing exteriors of an unmanned aerial vehicle (UAV) and a remote operation device according to some exemplary embodiments of the present disclosure; and

FIG. 9 is a diagram showing a hardware composition according to some exemplary embodiments of the present disclosure.

### DETAILED DESCRIPTION

The following describes the present disclosure by using implementations of the disclosure. However, the following implementations do not limit the claims. In addition, all combinations of features described in the implementations may not be necessary for solutions of the disclosure. Evidently, a person of ordinary skill in the art may make various changes or improvements to the following implementations. It is apparent from the description of the claims that such changes or improvements should fall within the technical scope of the present disclosure.

It should be noted that, when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used in the present disclosure are the same as those generally understood by persons skilled in the art of the present disclosure. The terms used in the present disclosure of the present disclosure herein are used only to describe specific embodiments, and not intended to limit the present disclosure. The term “and/or” used in the present disclosure includes any or all possible combinations of one or more associated listed items.

The following describes in detail some implementations of the present disclosure with reference to the accompanying drawings. Under a condition that no conflict occurs, the following embodiments and features in the embodiments may be mutually combined. The following description provides specific application scenarios and requirements of the present application in order to enable those skilled in the art to make and use the present application. Various modifications to the disclosed embodiments will be apparent to those skilled in the art. The general principles defined herein may be applied to other embodiments and applications without departing from the spirit and scope of the disclosure. Therefore, the present disclosure is not limited to the embodiments shown, but the broadest scope consistent with the claims.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some embodiments, the numerical parameters set forth in the written description and the appended claims are approximations, which may vary depending upon the desired properties sought to be obtained in a particular embodiment. In some embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the technical solution in this application in accordance with the embodiments of the present application. Therefore, the embodiments of the present application are not limited to those embodiments that have been precisely described in this disclosure.

The following describes the present disclosure by using implementations of the present disclosure. However, the following implementations do not limit the claims. In addition, all feature combinations described in the implementations are not necessarily mandatory for solutions of the present disclosure. For a person of ordinary skill in the art, various variations or improvements may be made to the following implementations. Obviously, from the descriptions of the claims, any manner of such variations or improvements may be included in the technical scope of the present disclosure.

The claims, the specification, the accompanying drawings, and the abstract may include matters that are subject to copyright protection. The copyright holder will not raise an objection to the facsimile reproduction by anyone of the patent document or the patent disclosure, as it appears in the Patent and Trademark Office patent file or records, but otherwise reserves all copyright rights whatsoever.

Various implementations of the present disclosure may be described with reference to flowcharts and block diagrams. Herein, a block may indicate (1) a stage of a process for performing an operation or (2) a “unit” of an apparatus having a function of performing an operation. The specific stage and “unit” may be implemented by a programmable circuit and/or a processor. A dedicated circuit may include a digital and/or analog hardware circuit and may include integrated circuit (IC) and/or a discrete circuit. The programmable circuit may include a reconfigurable hardware circuit. The reconfigurable hardware circuit may include logic AND, logic OR, logic XOR, logic NAND, logic NOR, and other logic operations, and storage elements such as a trigger, a register, a field programmable gate array (FPGA), a programmable logic array (PLA).

A computer-readable medium may include any tangible device that may store at least one instruction executable by an appropriate device. As a result, the computer-readable medium storing at least one instruction may include a product including at least one instruction executable to create means for performing operations specified by the flowcharts or block diagrams. An example of the computer-readable medium may include but not limited to an electronic storage medium, a magnetic storage medium, an optical storage medium, an electromagnetic storage medium, a semiconductor storage medium, and the like. A specific example of the computer-readable medium may include a floppy™ disk, a diskette, a hard disk, a random-access memory (RAM), a read-only memory (ROM), an erasable programmable ROM (EPROM or flash memory), an electrically erasable programmable ROM (EEPROM), a static RAM (SRAM), a compact disc ROM (CD-ROM), a digital versatile disc (DVD), a Blu-ray (registered trademark) disc, a memory stick, an integrated circuit card, or the like.

At least one computer-readable instruction may include any one of source code or object code described by any combination of one or more programming languages. The source code or the object code may include a conventional program-mode programming language. The conventional program-mode programming language may be an object-oriented programming language and the “C” programming language or a similar programming language, for example, an assembly instruction, an instruction set architecture (ISA) instruction, a machine instruction, a machine-related instruction, a microcode, a firmware instruction, status setting data, or Smalltalk™, JAVA™, or C++. The computer-readable instruction may be provided locally or through a local area network (LAN), a wide area network (WAN) such as the Internet to a processor or a programmable circuit of a general-purpose computer, a dedicated computer, or another programmable data processing apparatus. The processor or the programmable circuit may execute the at least one computer readable instruction to create a means for performing the operations specified by the flowcharts or the block diagrams. A non-limiting example of the processor may include a computer processor, a processing unit, a microprocessor, a digital signal processor, a control apparatus, a micro-control apparatus, or the like.

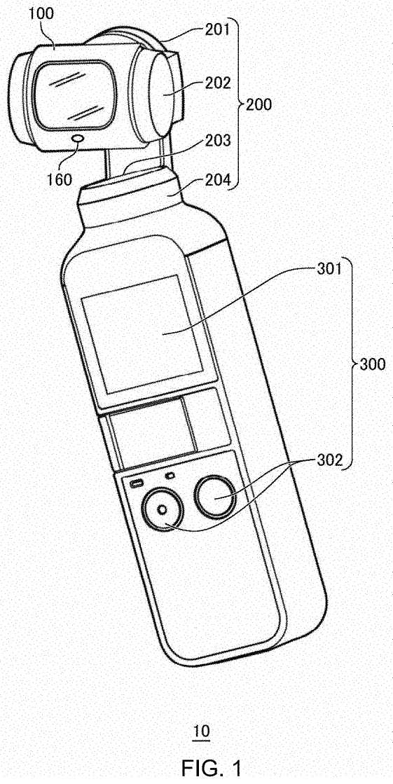

FIG. 1 is a perspective view of a photographing system 10 according some exemplary embodiments of the present disclosure. The photographing system 10 may include a photographing apparatus 100, a support mechanism 200, and a grip unit 300. The photographing apparatus 100 may include a Time-of-flight (TOF) sensor 160. The support mechanism 200 may use at least one actuator to rotatably support the photographing apparatus 100 around a roll axis, a pitch axis, and a yaw axis, respectively. The support mechanism 200 may change or maintain an attitude of the photographing apparatus 100 by causing the photographing apparatus 100 to rotate around at least one of the roll axis, the pitch axis, or the yaw axis. The support mechanism 200 may include a roll axis driving mechanism 201, a pitch axis driving mechanism 202, and a yaw axis driving mechanism 203. The support mechanism 200 may further include a base unit 204 for fixing the yaw axis driving mechanism 203. The grip unit 300 may be fixed to the base unit 204. The grip portion 300 may include an operation interface 301 and a display unit 302. The photographing apparatus 100 may be fixed to the pitch axis driving mechanism 202.

The operation interface 301 may receive, from a user, a command for operating the photographing apparatus 100 and the support mechanism 200. The operation interface 301 may include a shutter/recording button to instruct the photographing apparatus 100 to shoot a picture or record a video. The operation interface 301 may include a power/function button, to turn on or off a power supply of the photographing system 10 or to switch between a still image photographing mode or a motion picture photography mode of the photographing apparatus 100.

The display unit 302 may display an image obtained by the photographing apparatus 100. The display unit 302 may display a menu screen for operating the photographing apparatus 100 and the support mechanism 200. The display unit 302 may be a touch panel display, and may receive a command for operating the photographing apparatus 100 and the support mechanism 200.

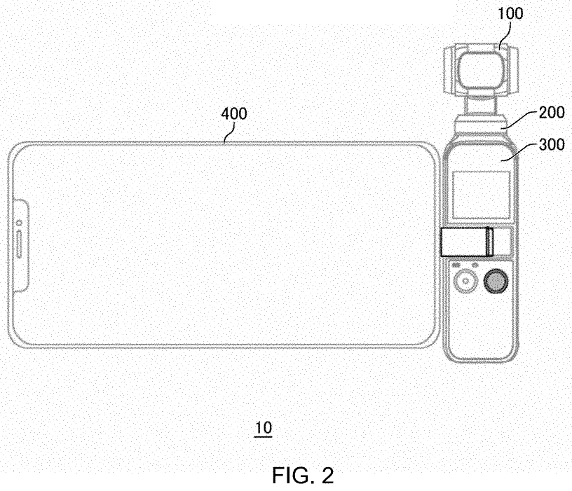

FIG. 2 is a perspective view of the photographing system 10 according to some exemplary embodiments of the present disclosure. As shown in FIG. 2, the photographing system 10 may be used in a state in which a mobile terminal including a display of a smartphone 400 or the like is fixed to the side of the grip unit 300. A user may hold the grip unit 300, and may obtain a still image or a video by using the photographing apparatus 100. The display of the smartphone 400 or the like may display the still image or the video obtained by the photographing apparatus 100.

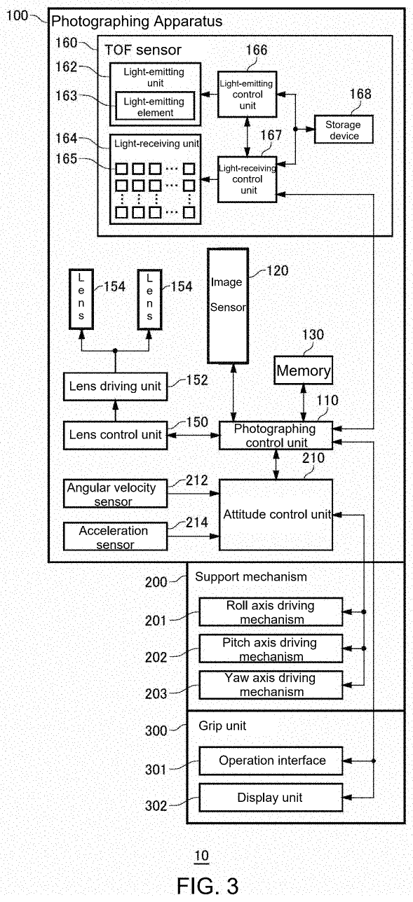

FIG. 3 is a functional bock diagram of the photographing system 10. The photographing apparatus 100 may include a photographing control unit 110, an image sensor 120, a memory 130, a lens control unit 150, a lens driving unit 152, a plurality of lenses 154, and a TOF sensor 160.

The image sensor 120 may include a Charge-coupled Device (CCD) or a Complementary Metal Oxide Semiconductor (CMOS). The image sensor 120 may be a non-limiting example of an image sensor for photographing. The image sensor 120 may output image data of an optical image formed through the plurality of lenses 154 to the photographing control unit 110. The photographing control unit 110 may include a microprocessor such as a Central Processing Unit (CPU) or a Microprocessor Unit (MPU), and a micro-control apparatus such as a Microcontroller Unit (MCU).

The photographing control unit 110 may follow an action instruction of the grip unit 300 to the photographing apparatus 100, and the photographing control unit 110 may implement mosaic removing processing on an image signal output from the image sensor 120, to generate image data. The photographing control unit 110 may store the image data in the memory 130. The photographing control unit 110 may control the TOF sensor 160. The photographing control unit 110 may be a non-limiting example of a circuit. The TOF sensor 160 may be a time-of-flight type sensor that measure a distance to an object. The photographing apparatus 100 may adjust a location of a focusing lens according to a distance measured by the TOF sensor 160, to perform focus control.

The memory 130 may be a computer readable storage medium, and may include at least one of a SRAM, a DRAM, an EPROM, an EEPROM, or a flash memory such as a USB memory. The memory 130 may store a program necessary for the photographing control unit 110 to control the image sensor 120, and the like. The memory 130 may be disposed inside a housing of the photographing apparatus 100. The grip unit 300 may include another memory configured to store the image data obtained by the photographing apparatus 100. The grip portion 300 may have a slot through which the memory may be detached from a housing of the grip unit 300.

The plurality of lenses 154 may function as a zoom lens, a varifocal lens, and a focusing lens. At least one of the plurality of lenses 154 may be configured to move along an optical axis. The lens control unit 150 may drive, according to a lens control instruction from the photographing control unit 110, the lens driving unit 152 to cause the plurality of lenses 154 to move along a direction of the optical axis. The lens control instruction may be, for example, a zoom control instruction or a focus control instruction. The lens driving unit 152 may include a voice coil motor (VCM) that causes at least one of the plurality of lenses 154 to move along the direction of the optical axis. The lens driving unit 152 may include an electric motor such as a DC motor, a coreless motor, or an ultrasonic motor. The lens driving unit 152 may transmit power from the electric motor to at least one of the plurality of lenses 154 through a mechanism component such as a cam ring and a guide shaft, to cause at least one of the plurality of lenses 154 to move along the optical axis.

The photographing apparatus 100 may further include an attitude control unit 210, an angular velocity sensor 212, and an acceleration sensor 214. The angular velocity sensor 212 may detect an angular velocity of the photographing apparatus 100. The angular velocity sensor 212 may detect an angular velocity of the photographing apparatus 100 around each of the roll axis, the pitch axis, and the yaw axis. The attitude control unit 210 may obtain angular velocity information related to the angular velocity of the photographing apparatus 100 from the angular velocity sensor 212. The angular velocity information may show the angular velocity of the photographing apparatus 100 around each of the roll axis, the pitch axis, and the yaw axis. The attitude control unit 210 may obtain acceleration information related to acceleration of the photographing apparatus 100 from the acceleration sensor 214. The acceleration information may also indicate acceleration of the photographing apparatus 100 in each direction of the roll axis, the pitch axis, and the yaw axis.

The angular velocity sensor 212 and the acceleration sensor 214 may be disposed in a housing for accommodating the image sensor 120, the lenses 154, and the like. In some exemplary embodiments, the photographing apparatus 100 and the support mechanism 200 may be integrally formed together. However, the support mechanism 200 may include a base for detachably fixing the photographing apparatus 100. In this case, the angular velocity sensor 212 and the acceleration sensor 214 may be disposed outside the housing of the photographing apparatus 100, for example, the acceleration sensor 214 may be disposed on the base.

The attitude control unit 210 may control the support mechanism 200 according to the angular velocity information and the acceleration information, to maintain or change the attitude of the photographing apparatus 100. The attitude control unit 210 may control the support mechanism 200 according to a working mode of the support mechanism 200 for controlling the attitude of the photographing apparatus 100, to maintain or change the attitude of the photographing apparatus 100

The working mode may include the following mode: causing at least one of the roll axis driving mechanism 201, the pitch axis driving mechanism 202, or the yaw axis driving mechanism 203 of the support mechanism 200 to operate, so that the attitude of the photographing apparatus 100 may vary with a change in an attitude of the base unit 204 of the support mechanism 200. An operation mode may include the following mode: causing the roll axis driving mechanism 201, the pitch axis driving mechanism 202, and the yaw axis driving mechanism 203 of the support mechanism 200 to operate separately, so that the attitude of the photographing apparatus 100 may vary with a change in an attitude of the base unit 204 of the support mechanism 200. An operation mode may include the following mode: causing the pitch axis driving mechanism 202 and the yaw axis driving mechanism 203 of the support mechanism 200 to operate separately, so that the attitude of the photographing apparatus 100 may vary with a change in an attitude of the base unit 204 of the support mechanism 200. An operation mode may include the following mode: causing only the yaw axis driving mechanism 203 to operate, so that the attitude of the photographing apparatus 100 may vary with a change in an attitude of the base unit 204 of the support mechanism 200.

The working mode may include a first-person view (FPV) mode and a fixed mode. In the FPV mode, the support mechanism 200 may be in operation, so that the attitude of the photographing apparatus 100 may vary with a change in an attitude of the base unit 204 of the support mechanism 200. In the fixed mode, the support mechanism 200 may be in operation to maintain the attitude of the photographing apparatus 100.

The FPV mode may be a mode in which at least one of the roll axis driving mechanism 201, the pitch axis driving mechanism 202, or the yaw axis driving mechanism 203 is in operation so that the attitude of the photographing apparatus 100 may vary with the change in the attitude of the base unit 204 of the support mechanism 200. The fixed mode may be a mode in which at least one of the roll axis driving mechanism 201, the pitch axis driving mechanism 202, or the yaw axis driving mechanism 203 is in operation so that a current attitude of the photographing apparatus 100 may be maintained.

The TOF sensor 160 may include a light-emitting unit 162, a light-receiving unit 164, a light-emitting control unit 166, a light-receiving control unit 167, and a storage device 168. The TOF sensor 160 may be a non-limiting example of a ranging sensor.

The light-emitting unit 162 may include at least one light-emitting element 163. The light-emitting element 163 may be a device that repeatedly emits high-speed modulated pulsed light such as LEDs or lasers. The light-emitting element 163 may emit pulsed light which may be infrared light. The light-emitting control unit 166 may control light emission of the light-emitting element 163. The light-emitting control unit 166 may control a pulse width of the pulsed light emitted from the light-emitting element 163.

The light-receiving unit 164 may include a plurality of light-receiving elements 165 measuring the distance to a to-be-photographed subject (i.e., a target subject) or a to-be-photographed object (i.e., a target object) associated with each of a plurality of regions. The light-receiving unit 164 may be a non-limiting example of an image sensor for distance measurement. The plurality of light-receiving elements 165 may be respectively associated with the plurality of regions. The light-receiving element 165 may repeatedly receive reflected light of pulsed light from an object. The light-receiving element 165 may receive light that includes the reflected light of the pulsed light from the object, and may output a signal associated with an amount of the received light. The light-receiving control unit 167 may control the light-receiving element 165 to receive light. The light-receiving control unit 167 may measure, according to the signal output from the light-receiving element 165, the distance to the to-be-photographed object associated with each of the plurality of regions. The light-receiving control unit 167 may measure, according to an amount of the reflected light repeatedly received by the light-receiving element 165 within a preset light receiving period, the distance to the to-be-photographed object associated with each of the plurality of regions. The light-receiving control unit 167 may measure the distance to the to-be-photographed object according to the amount of the reflected light repeatedly received by the light-receiving element 165 within the preset light receiving period, by determining a phase difference between the pulsed light and the reflected light. The light-receiving unit 164 may measure the distance to the to-be-photographed object by reading a frequency change of a reflected wave. This is referred to as a frequency modulated continuous wave (FMCVV) method.

The storage device 168 may be a computer readable recording medium, and may include at least one of: a SRAM, a DRAM, an EPROM, or an EEPROM. The storage device 168 may store a program required for the light-emitting control unit 166 to control the light-emitting unit 162, a program required for the light-receiving control unit 167 to control the light-receiving portion 164, or the like.

An autofocus (AF) method performed by the photographing apparatus 100 is described herein. The photographing apparatus 100 may move the focusing lens according to a distance from the photographing apparatus 100 to the to-be-photographed object (an object distance) that is measured by the TOF sensor 160, to control a location relationship between the focusing lens and an image-taking surface of the image sensor 120. The photographing apparatus 100 may determine, according to the distance from the photographing apparatus 100 to the to-be-photographed object (the object distance) that is measured by the TOF sensor 160, a target location of the focusing lens focusing on the to-be-photographed object, and move the focusing lens to the target location, to perform focus control.

The photographing control unit 110 may determine, according to distance information indicating a distance of a first region of interest (ROI) including a primary to-be-photographed object (i.e., a first target object) in the plurality of regions measured by the TOF sensor 160, a target location of the focusing lens focusing on the primary to-be-photographed object. The photographing control unit 110 may move the focusing lens to the target location. In this way, the photographing control unit 110 may perform focus control on the primary to-be-photographed object.

In the photographing system 10, in some exemplary embodiments, a moving object or a moving object may pass between the primary to-be-photographed object and the photographing apparatus 100. In such cases, the distance to the first region measured by the TOF sensor 160 may be a distance to the moving object instead of a distance to the primary to-be-photographed object. In such cases, when the photographing control unit 110 performs focus control according to the distance information from the TOF sensor 160, there may be cases in which the primary to-be-photographed object is not focused.

Therefore, in some exemplary embodiments of the present disclosure, when a to-be-photographed object other than the primary to-be-photographed object, that is, a non-primary to-be-photographed object (i.e., a second target object), exists in the first region associated with the primary to-be-photographed object among the plurality of regions measured by the TOF sensor 160, the photographing control unit 110 does not perform focus control according to the distance information about the first region measured by the TOF sensor 160. This may prevent the photographing apparatus 100 from focusing on a non-primary to-be-photographed object instead of a primary to-be-photographed object due to the focus control performed by the TOF sensor 160 according to the measured distance information.

The photographing control unit 110 may cause, according to a first distance to the primary to-be-photographed object (a first to-be-photographed object) associated with the first region in the plurality of regions measured by the TOF sensor 160, the photographing apparatus 100 to perform the focus control on the first to-be-photographed object. And then the photographing control unit 110 may determine, according to a plurality of images obtained by the photographing apparatus 100, whether a non-primary to-be-photographed object, that is, a second to-be-photographed object as a moving object exists in the first region. The first region may be divided into a plurality of regional blocks. When the non-primary to-be-photographed object (a second to-be-photographed object) exists in at least one of the plurality of regional blocks, the photographing control unit 110 may determine that the moving object, that is, the non-primary to-be-photographed object, exists in the first region. When the non-primary to-be-photographed object, that is, the second to-be-photographed object, exists in a quantity of the plurality of regional blocks greater than or equal to a preset quantity, the photographing control unit 110 may determine that the non-primary to-be-photographed object is the moving object, that is, the second to-be-photographed object exists in the first region.

The photographing control unit 110 may derive an optical flow associated with the first region according to the plurality of images obtained by the photographing apparatus 100, and may determine, according to the optical flow, whether the second to-be-photographed object exists in the first region. The photographing control unit 110 may divide each of the plurality of images into a plurality of regional blocks, and may derive a movement vector based on each regional block, to derive the optical flow. The photographing control unit 110 may derive the optical flow by deriving a movement vector for each pixel forming each image.

The photographing control unit 110 may determine, according to at least one of luminance information, color information, edge information, or contrast information of each of the plurality of images obtained by the photographing apparatus 100, whether the second to-be-photographed object exists in the first region. For example, the photographing control unit 110 may divide the plurality of images into a plurality of regional blocks, compare luminance information, color information, edge information, or contrast information of the regional blocks, and determine a change therein over time to determine whether the second to-be-photographed object exists in the first region.

When it is determined that the second to-be-photographed object does not exist in the first region, the photographing control unit 110 may cause the photographing apparatus 100 to perform focus control according to a second distance to the first to-be-photographed object associated with the first region that is further measured by the TOF sensor 160. When it is determined that the second to-be-photographed object exists in the first region, the photographing control unit 110 may cause the photographing apparatus 100 not to perform focus control according to the second distance.

When a viewing angle of the TOF sensor 160 is smaller than a viewing angle of the photographing apparatus 100, the photographing control unit 110 may determine whether the second to-be-photographed object exists in the first region. If the viewing angle of the photographing apparatus 100 is greater than the viewing angle of the TOF sensor 160, the photographing control unit 110 may determine, according to an image obtained by the photographing apparatus 100, whether a non-primary to-be-photographed object exists outside the viewing angle of the TOF sensor 160.

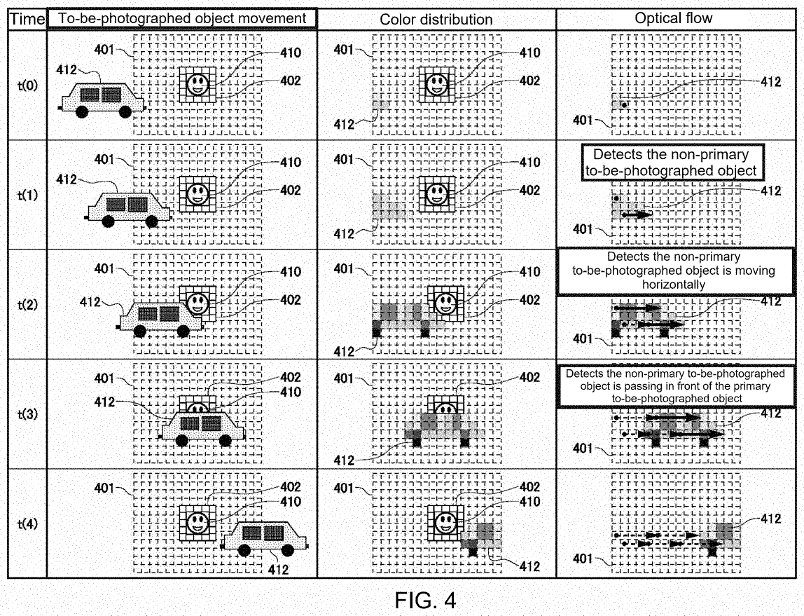

FIG. 4 is a diagram showing color distribution and optical flow when a non-primary to-be-photographed object crosses in front of a primary to-be-photographed object according to some exemplary embodiments of the present disclosure. At a time t(0), the photographing control unit 110 may perform focus control according to distance measurement information of the TOF sensor 160, to focus on a primary to-be-photographed object 410 in a region of interest (ROI) of the TOF sensor 160. In addition, the non-primary to-be-photographed object 412 may enter a photographing region 401 of the photographing apparatus 100. The non-primary to-be-photographed object 412 may move along a horizontal direction from a left side to a right side in the photographing region 401.

At a time t(1), the photographing control unit 110 may detect existence of the non-primary to-be-photographed object 412 according to the optical flow.

Further, at a time t(2), the photographing control unit 110 may determine, according to the optical flow, that the non-primary to-be-photographed object 412 is moving along the horizontal direction from the left side to the right side. Next, at a time t(3), the photographing control unit 110 may detect, according to the optical flow, that the non-primary to-be-photographed object is passing in front of the primary to-be-photographed object. That is, the photographing control unit 110 may detect, according to the optical flow, that the non-primary to-be-photographed object 412 exists in the ROI of the TOF sensor 160. In this case, the photographing control unit 110 does not perform focus control according to the distance information measured by the ROI of the TOF sensor 160. The photographing control unit 110 may detect, according to a change in color distribution, existence of the non-primary to-be-photographed object 412 and the existence of the non-primary to-be-photographed object 412 in the ROI of the TOF sensor 160.

Thereafter, at a time t(4), the photographing control unit 110 may detect, according to the optical flow, that the non-primary to-be-photographed object 412 does not exist in the ROI of the TOF sensor 160. Therefore, the photographing control unit 110 may restart the focus control according to the distance information measured by the ROI of the TOF sensor 160.

However, the viewing angle of the photographing apparatus 100 may be smaller than the viewing angle of the TOF sensor 160. Additionally, the support mechanism 200 may drive the photographing apparatus 100 to rotate along a direction to which a photographing direction of the photographing apparatus 100 is to be changed to (a to-be-changed-to photographing direction) while performing photographing. In this case, the TOF sensor 160 may measure a distance to a to-be-photographed object outside the viewing angle of the photographing apparatus 100 in advance, so that the to-be-photographed object outside the viewing angle of the photographing apparatus 100 may be focused on in a short time.

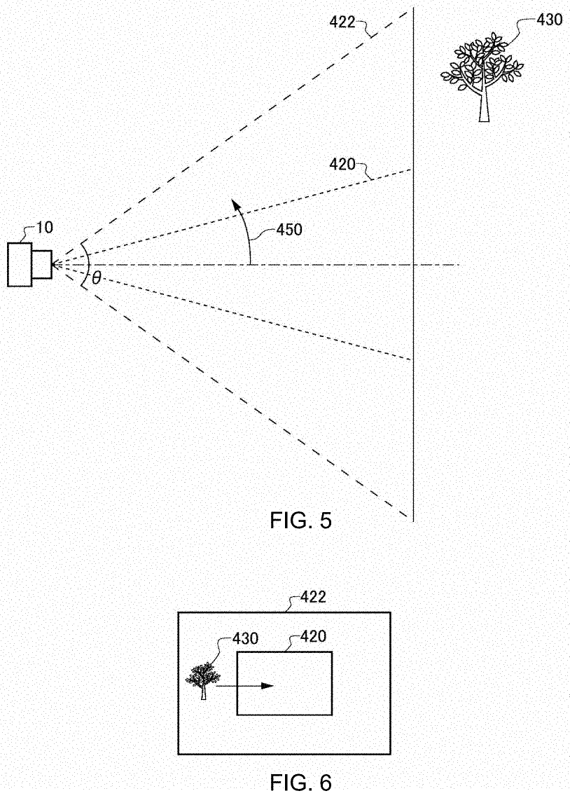

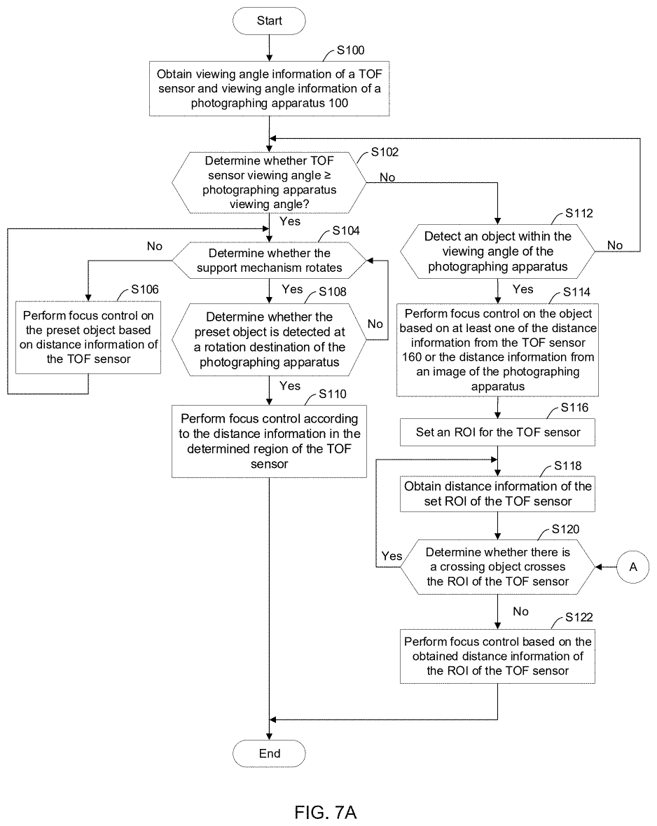

For example, as shown in FIG. 5 and FIG. 6, in some exemplary embodiments, the viewing angle 422 of the TOF sensor 160 may be greater than the viewing angle 420 of the photographing apparatus 100. In this case, the support mechanism 200 may drive the photographing apparatus 100 to rotate along a first direction (a yaw direction or a pitch direction) 450, that is, the to-be-changed-to photographing direction of the photographing apparatus 100, and may cause the photographing apparatus 100 to focus on a to-be-photographed object 430 (i.e., a third target object) outside the viewing angle of the photographing apparatus 100 and perform photographing. In this case, the TOF sensor 160 may measure a distance to the to-be-photographed object 430 in advance before the to-be-photographed object 430 enters the viewing angle of the photographing apparatus 100. Then, when the to-be-photographed object 430 enters the viewing angle of the photographing apparatus 100, the photographing apparatus 100 may focus on the to-be-photographed object 430 according to distance information measured by the TOF sensor 160.

More specifically, when the viewing angle of the TOF sensor 160 is greater than the viewing angle of the photographing apparatus 100, the photographing control unit 110 may determine, according to a control command on the support mechanism 200, whether the support mechanism 200 causes the photographing apparatus 100 to rotate along the first direction, that is, the to-be-changed-to photographing direction of the photographing apparatus. The photographing control unit 110 may determine, according to the control command on the support mechanism 200, whether to cause the support mechanism 200 to rotate along the yaw direction or the pitch direction.

When it is determined that the support mechanism 200 causes the photographing apparatus 100 to rotate along the first direction, the photographing control unit 110 may determine, from the plurality of regions measured by the TOF sensor 160, a third region where the photographing apparatus 100 is required to focus after the support mechanism 200 causes, according to the control command, the photographing apparatus 100 to rotate along the first direction by a first rotation amount. The third region may be a region outside the viewing angle 420 of the photographing apparatus 100 before the photographing apparatus 100 rotates along the first direction according to the control command.

The photographing control unit 110 may cause, according to a third distance to a third to-be-photographed object associated with the third region measured by the TOF sensor 160, and during rotation of the photographing apparatus 100 along the first direction by the first rotation amount, the photographing apparatus 100 to perform focus control on the third to-be-photographed object.

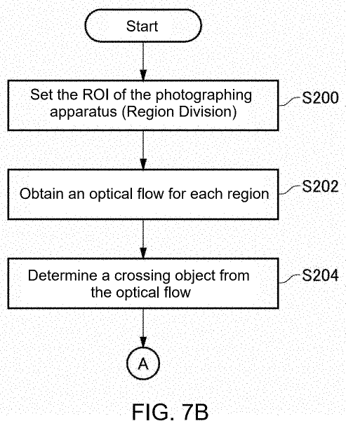

FIG. 7A and FIG. 7B are each a flow chart of a focus control performed by using the photographing system 10. The photographing control unit 110 may obtain viewing angle information of the TOF sensor 160 and viewing angle information of the photographing apparatus 100 (S100). The photographing control unit 110 may obtain the viewing angle information of the TOF sensor 160 and the viewing angle information of the photographing apparatus 100 stored in the memory 130 or storage device 168. The photographing control unit 110 may obtain the viewing angle information of the photographing apparatus 100 according to setting information of a zoom lens through the lens control unit 150.

The photographing control unit 110 may determine whether the viewing angle of the TOF sensor 160 is not smaller than the viewing angle of the photographing apparatus 100 (S102). When the viewing angle of the TOF sensor 160 is not smaller than the viewing angle of the photographing apparatus 100, the photographing control unit 110 may obtain control information of the support mechanism 200 through the attitude control unit 210. The photographing control unit 110 may determine whether the control information indicates that the support mechanism 200 rotates along a yaw direction or a pitch direction (S104).

When the control information does not indicate that the support mechanism 200 rotates along the yaw direction or the pitch direction, the photographing control unit 110 may perform focus control by focusing on a preset object according to distance information in a ROI obtained by the TOF sensor 160 (S106). When the control information indicates that the support mechanism 200 rotates along the yaw direction or the pitch direction, the photographing control unit 110 may determine whether the preset object may be detected at a rotation destination of the photographing apparatus 100 within the viewing angle of the TOF sensor 160 (S108). The photographing control unit 110 may determine, according to the control information, a first direction in which the photographing apparatus 110 rotates along, and a first rotation amount in which the photographing apparatus rotates by. When the photographing apparatus 100 rotates along the first direction by the first rotation amount, the photographing control unit 110 may determine a region of the TOF sensor 160 in which a preset region such as the ROI of the photographing apparatus 100 is located. When distance information in the determined region of the TOF sensor 160 indicates a preset distance range, the photographing control unit 110 may determine that the preset object may be detected at the rotation destination of the photographing apparatus 100.

During the rotation of the photographing apparatus 100 along the first direction by the first rotation amount, the photographing control unit 110 may perform focus control according to the distance information in the determined region of the TOF sensor 160 (S110).

When the viewing angle of the photographing apparatus 100 is greater than the viewing angle of the TOF sensor 160, the photographing control unit 110 may detect an object within the viewing angle of the photographing apparatus 100 (S112). The photographing control unit 110 may detect an object satisfying a preset condition from a preset ROI of the photographing apparatus 100 within the viewing angle of the photographing apparatus 100. The photographing control unit 110 may detect an object satisfying a preset condition such as a face within the viewing angle of the photographing apparatus 100.

The photographing control unit 110 may perform focus control on the detected object according to distance information from the TOF sensor 160 or distance information determined from an image of the photographing apparatus 100 (S114). The photographing control unit 110 may set a region(s) in a plurality of regions in which the detected object exists as measured by the TOF sensor 160 as the ROI of the TOF sensor 160 (S116).

The photographing control unit 110 may obtain distance information of the set ROI of the TOF sensor 160 (S118). The photographing control unit 110 may determine whether there is a crossing object that crosses the ROI of the TOF sensor 160 (S120).

As shown in FIG. 7B, in order to determine whether there is a crossing object, the photographing control unit 110 may set a ROI of the photographing apparatus 100. The photographing control unit 110 may divide the ROI into a plurality of regions (S200), and may obtain an optical flow for each region (S202). In addition, the photographing control unit 110 may determine, according to the optical flow for each region, whether there is a crossing object that crosses the ROI of the TOF sensor 160 (S204).

When there is a crossing object that crosses the ROI of the TOF sensor 160, the photographing control unit 110 may not perform focus control according to the distance information obtained in step S118, but instead, obtains the distance information of the ROI of the TOF sensor 160 again.

When there is no crossing object that crosses the ROI of the TOF sensor 160, the photographing control unit 110 may perform focus control according to the distance information obtained in step S118, that is, controls the focusing lens to focus on the object detected in the step S112 (S122).

As described above, in some exemplary embodiments of the present disclosure, the photographing control unit 110 may detect a change in the photographing direction of the photographing apparatus 100 according to the control information of the support mechanism 200. Then, the photographing control unit 110 may obtain, in advance from the TOF sensor 160, distance information of a photographing target object after the photographing direction of the photographing apparatus 100 changes, and the photographing apparatus 100 may perform focus control according to the distance information before completion of the change in the photographing direction of the photographing apparatus 100. In this way, focus control may be quickly performed on the object.

In addition, the photographing control unit 110 may detect, according to a plurality of images of the photographing apparatus 100, a crossing object that crosses the ROI of the TOF sensor 160. In addition, when the crossing object is detected, the photographing control unit 110 may not perform focus control according to the distance information of the ROI detected by the TOF sensor 160 in this case. In this way, the photographing apparatus 100 may be prevented from incorrectly focusing on the crossing object according to the distance information from the TOF sensor 160.

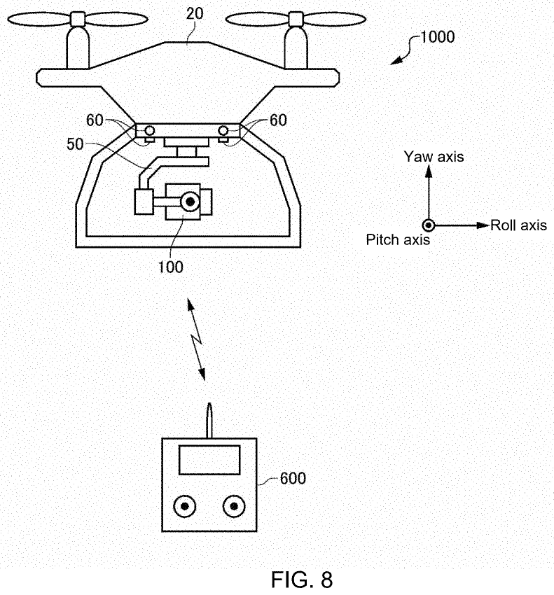

The photographing apparatus 100 may be mounted on a movable object. The photographing apparatus 100 may alternatively be mounted on a UAV shown in FIG. 8. A UAV 1000 may include a UAV main body 20, a universal joint 50, a plurality of photographing devices 60, and a photographing apparatus 100. The universal joint 50 and the photographing apparatus 100 may be non-limiting examples of a photographing system. The UAV 1000 may be a non-limiting example of a movable object propelled by a propulsion unit. A non-limiting exemplary movable object may be a flying object such as an airplane movable in the air, a vehicle movable on the ground, a ship movable on the water, or the like, in addition to the UAV.

The UAV main body 20 may include a plurality of propellers. The plurality of propellers may be a non-limiting example of the propulsion unit. The UAV main body 20 may control the plurality of propellers to rotate to enable the UAV 1000 to fly. The UAV main body 20 may use, for example, four propellers to enable the UAV 1000 to fly. A quantity of the propellers is not limited to four. Any number(s) of the propellers may be used. In addition, the UAV 1000 may alternatively be a fixed-wing aircraft without any propellers.

The photographing apparatus 100 may be a camera for photographing a to-be-photographed object included in a desired photographing range. The universal joint 50 may rotatably support the photographing apparatus 100. The universal joint 50 may be a non-limiting example of a support mechanism. For example, the universal joint 50 may use an actuator to rotatably support the photographing apparatus 100 around a pitch axis. The universal joint 50 may use the actuator to further rotatably support the photographing apparatus 100 with a roll axis and a yaw axis as centers. The universal joint 50 may change an attitude of the photographing apparatus 100 by causing the photographing apparatus 100 to rotate around at least one of the yaw axis, the pitch axis, or the roll axis.

The plurality of photographing devices 60 may be cameras for sensing and photographing surroundings of the UAV 1000 to control the flight of the UAV 1000. For example, the UAV 1000 may include four photographing devices 60. Two photographing devices 60 may be arranged on a nose, that is, a front side of the UAV 1000. In addition, the other two photographing devices 60 may be arranged on a bottom surface of the UAV 1000. The two photographing devices 60 on the front side may be paired to function as a stereoscopic camera. The two photographing devices 60 on the bottom surface side may also be paired to function as a stereoscopic camera. Three-dimensional space data around the UAV 1000 may be generated according to images obtained by the plurality of photographing devices 60. A quantity of photographing devices 60 included by the UAV 1000 is not limited to four. Any quantity of the photographing devices 60 of the UAV 10 may be used. For example, the UAV 1000 may include at least one photographing device 60. In some exemplary embodiments, the UAV 1000 may include at least one photographing device 60 on each of the nose, a tail, a side surface, the bottom surface, and a top surface of the UAV 1000. A viewing angle settable in the photographing device 60 may be greater than a viewing angle that may be set in the photographing apparatus 100. The photographing device 60 may also have a single focus lens or a fisheye lens.

The remote operation device 600 may communicate with the UAV 1000 to remotely operate the UAV 1000. The remote operation device 600 may perform wireless communication with the UAV 1000. The remote operation device 600 may send, to the UAV 1000, indication information of various instructions related to movements of the UAV 1000 such as ascending, descending, accelerating, decelerating, moving forward, moving backward, and rotating. The indication information may include, for example, indication information causing the UAV 1000 to ascend. The indication information may indicate a height at which the UAV 1000 should be located. The UAV 1000 may move to a height indicated by the indication information received from the remote operation device 600. The indication information may include an ascending instruction to cause the UAV 1000 to ascend. The UAV 1000 may ascend after receiving the ascending instruction. When the flight height of the UAV 1000 has reached an upper height limit, ascending of the UAV 1000 may be limited even if the ascending instruction is received.

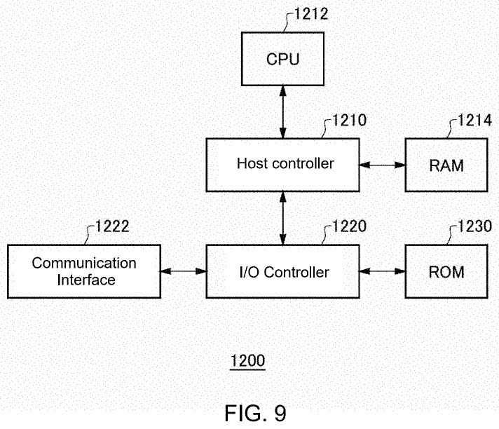

FIG. 9 is a diagram showing a computer 1200 that may reflect a plurality of manners of the present disclosure completely or partially according to some exemplary embodiments of the present disclosure. A program installed in the computer 1200 may enable the computer 1200 to function as an operation associated with the apparatus related in the implementations of the present disclosure or one or more “units” of the apparatus. Alternatively, the program may enable the computer 1200 to perform the operation or the one or more “units”. The program may enable the computer 1200 to perform the process in the implementations of the present disclosure or a stage of the process. Such a program may be executed by the CPU 1212, to enable the computer 1200 to perform specified operations associated with some or all of the blocks in the flowcharts and the block diagrams described in this specification.

In some exemplary embodiments of the present disclosure, the computer 1200 may include a CPU 1212 and a RAM 1214, which may be connected to each other through a host control apparatus 1210. The computer 1200 may further include a communications interface 1222 and an input/output unit, which may be connected to the host control apparatus 1210 through an input/output controller 1220. The computer 1200 may further include a ROM 1230. The CPU 1212 may operate according to programs stored in the ROM 1230 and the RAM 1214 to control each unit.

The communications interface 1222 may communicate with another electronic apparatus through a network. A hard disk drive may store programs and data used by the CPU 1212 in the computer 1200. The ROM 1230 may store a boot program executable by the computer 1200 during operation, and/or a program that depends on hardware of the computer 1200. The programs may be provided through a computer readable recording medium such as a CR-ROM, a USB memory, or an IC card, or a network. The programs may be installed in the RAM 1214 or the ROM 1230 that also functions as a computer readable recording medium, and may be executed by the CPU 1212. Information processing recorded in these programs may be read by the computer 1200, and may cause cooperation between the programs and the foregoing various types of hardware resources. An information operation or processing may be implemented based on use of the computer 1200 to constitute an apparatus or a method.

For example, when the computer 1200 communicates with an external apparatus, the CPU 1212 may execute a communication program loaded in the RAM 1214, and may command, based on processing described in the communication program, the communications interface 1222 to perform communication processing. Under the control of the CPU 1212, the communications interface 1222 may read and send data stored in a send buffer provided in a recording medium such as the RAM 1214 or a USB memory, and may send the read sent data to a network, or may write received data received from the network into a receiving buffer provided by the recording medium, or the like.

In addition, the CPU 1212 may enable the RAM 1214 to read all or a required part of files or databases stored in an external recording medium such as a USB memory, and may perform various types of processing on the data on the RAM 1214. Then, the CPU 1212 may write the processed data back to the external recording medium.

Various types of information such as various types of programs, data, tables, and databases may be stored in the recording medium, for information processing. For data read from the RAM 1214, the CPU 1212 may perform various types of processing such as various types of operations specified by an instruction sequence of the program, information processing, conditional judgement, conditional transfer, unconditional transfer, and information retrieval/replacement, which may be described throughout the present disclosure, and write results back into the RAM 1214. In addition, the CPU 1212 may retrieve information from a file, a database, or the like within the recording medium. For example, when the recording medium stores a plurality of entries having an attribute value of a first attribute respectively associated with an attribute value of a second attribute, the CPU 1212 may retrieve, from the plurality of entries, an entry matching a condition of the attribute value of the first attribute, and may read the attribute value of the second attribute stored in the entry, thereby obtaining the attribute value of the second attribute associated with the first attribute meeting a preset condition.

The forgoing program or software module may be stored in the computer 1200 or in a computer readable storage medium near the computer 1200. In addition, a recording medium such as a hard disk or a RAM provided in a server system connected to a dedicated communication network or the Internet may be used as a computer readable storage medium, so that the programs may be provided for the computer 1200 through the network.

The present invention is described above by using the implementations. However, the technical scope of the present disclosure is not limited to the scope described in the foregoing implementations. For a person of ordinary skill in the art may make various changes or improvements to the implementations. It is apparent from the description of the claims that all manners of such changes or improvements may be included within the technical scope of the present disclosure.

It should be noted that an execution order of various types of processing such as the action, sequence, step, and stage of the apparatus, system, program, and method in the claims, specification, and accompanying drawings of the specification may be implemented in any order, provided that there is no special statement such as “before . . . ” or “in advance”, and an output of previous processing is not used in subsequent processing. For the operation procedure in the claims, specification, and accompanying drawings of the specification, “first” and “next” and the like are used for ease of description, but it does not mean that an implementation must be implemented in such an order.

### REFERENCE NUMERALS

10 Photographing system

20 UAV main body

50 Universal joint

60 Photographing device

100 Photographing apparatus

110 Photographing control unit

120 Image sensor

130 Memory

150 Lens control unit

152 Lens driving unit

154 Lens

160 TOF sensor

162 Light-emitting unit

163 Light-emitting element

164 Light-receiving unit

165 Light-receiving element

166 Light-emitting control unit

167 Light-receiving control unit

168 Storage device

200 Support mechanism

201 Roll axis driving mechanism

202 Pitch axis driving mechanism

203 Yaw axis driving mechanism

204 Base unit

210 Attitude control unit

212 Angular velocity sensor

214 Acceleration sensor

300 Grip unit

301 Operation interface

302 Display unit

400 Smartphone

600 Remote operation device

1200 Computer

1210 Host control apparatus

1212 CPU

1214 RAM

1220 Input/Output controller

1222 Communications interface

1230 ROM

What is claimed is:

1. A control apparatus for controlling a photographing system, wherein the photographing system comprises:
a ranging sensor to measure distances of each to-be-photographed objects associated with each of a plurality of regions, wherein the plurality of to-be-photographed objects include a first target object, the first target object is associated with a first region and a first distance; and
a photographing apparatus to perform focus control based on the distances;
the control apparatus including:
a circuit configured to:
cause the photographing apparatus to perform focus control on the first target object based on the first distance,
control the photographing apparatus to obtain a plurality of images,
determine, based on the plurality of images, whether a second target object is in the first region, the second target object being a moving object in the first region; and
cause the photographing apparatus to perform different focus controls on the first region based on whether or not the second target object is present in the first region.

2. The control apparatus according to claim 1, wherein to cause the photographing apparatus to perform different focus controls on the first region based on whether or not the second target object is present in the first region, the circuit is configured to:
after determining that the second target object does not exist in the first region, cause the photographing apparatus to perform the focus control on the first target object based on a second distance measured by the ranging sensor.

3. The control apparatus according to claim 1, wherein to cause the photographing apparatus to perform different focus controls on the first region based on whether or not the second target object is present in the first region, the circuit is configured to:
after determining that the second to-be-photographed object exists in the first region, prohibit the photographing apparatus from performing the focus control on the first target object based on a second distance measured by the ranging sensor.

4. The control apparatus according to claim 1, wherein the circuit is configured to:
derive an optical flow associated with the first region based on the plurality of images obtained by the photographing apparatus, and
determine whether the second target object exists in the first region based on the optical flow.

5. The control apparatus according to claim 1, wherein the circuit is configured to:
determine whether the second target object exists in the first region based on at least one of luminance information, color information, edge information, or contrast information of each of the plurality of images obtained by the photographing apparatus.

6. The control apparatus according to claim 1, wherein the circuit is configured to: determine whether the second target object exists in the first region when a viewing angle of the ranging sensor is smaller than a viewing angle of the photographing apparatus.

7. The control apparatus according to claim 1, wherein the photographing system further includes a support mechanism rotatably supports the photographing apparatus, and
the circuit is configured to:
determine a viewing angle of the ranging sensor is greater than a viewing angle of the photographing apparatus,
determine, by the circuit based on a control command on the support mechanism, whether the support mechanism causes the photographing apparatus to rotate along a first to-be-changed-to direction of the photographing apparatus, and
determine a third region based on the plurality of regions measured by the ranging sensor in response to a determine that the support mechanism causes the photographing apparatus to rotate along the first to-be-changed-to direction, wherein
the photographing apparatus focuses on the third region after the support mechanism causes the photographing apparatus to rotate along the first to-be-changed-to direction by a first rotation amount based on the control command, and
cause the photographing apparatus to perform focus control on a third target object based on a third distance to the third target object in the third region while the photographing apparatus is rotating along the first to-be-changed-to direction.

8. The control apparatus according to claim 7, wherein the third region is a region outside the viewing angle of the photographing apparatus before the photographing apparatus rotates along the first to-be-changed-to direction based on the control command.

9. A photographing system, comprising:
a ranging sensor to measure distances of each to-be-photographed objects associated with each of a plurality of regions, wherein the plurality of to-be-photographed objects include a first target object, the first target object is associated with a first region and a first distance;
a photographing apparatus to perform focus control based on the distances; and
a control apparatus, including:
a circuit configured to:
cause the photographing apparatus to perform focus control on the first target object based on the first distance,
control the photographing apparatus to obtain a plurality of images, and
determine, based on the plurality of images, whether a second target object is in the first region, the second target object being a moving object in the first region; and
cause the photographing apparatus to perform different focus controls on the first region based on whether or not the second target object is present in the first region.

10. The photographing system according to claim 9, wherein to cause the photographing apparatus to perform different focus controls on the first region based on whether or not the second target object is present in the first region, the circuit is configured to:
after determining that the second target object does not exist in the first region, cause the photographing apparatus to perform the focus control on the first target object based on a second distance measured by the ranging sensor.

11. The photographing system according to claim 9, wherein to cause the photographing apparatus to perform different focus controls on the first region based on whether or not the second target object is present in the first region, the circuit is configured to:
after determining that the second to-be-photographed object exists in the first region, prohibit the photographing apparatus from performing the focus control on the first target object based on a second distance measured by the ranging sensor.

12. The photographing system according to claim 9, wherein the circuit is configured to:
derive an optical flow associated with the first region based on the plurality of images obtained by the photographing apparatus, and determine whether the second target object exists in the first region based on the optical flow.

13. The photographing system according to claim 9, wherein the circuit is configured to:
determine whether the second target object exists in the first region based on at least one of luminance information, color information, edge information, or contrast information of each of the plurality of images obtained by the photographing apparatus.

14. The photographing system according to claim 9, wherein the circuit is configured to: determine whether the second target object exists in the first region when a viewing angle of the ranging sensor is smaller than a viewing angle of the photographing apparatus.

15. The photographing system according to claim 9, wherein the photographing system further includes a support mechanism rotatably supports the photographing apparatus, and
the circuit is configured to:
determine a viewing angle of the ranging sensor is greater than a viewing angle of the photographing apparatus,
determine, by the circuit based on a control command on the support mechanism, whether the support mechanism causes the photographing apparatus to rotate along a first to-be-changed-to direction of the photographing apparatus, and
determine a third region based on the plurality of regions measured by the ranging sensor in response to a determine that the support mechanism causes the photographing apparatus to rotate along the first to-be-changed-to direction, wherein
the photographing apparatus focuses on the third region after the support mechanism causes the photographing apparatus to rotate along the first to-be-changed-to direction by a first rotation amount based on the control command, and
cause the photographing apparatus to perform focus control on a third target object based on a third distance to the third target object in the third region while the photographing apparatus is rotating along the first to-be-changed-to direction.

16. The photographing system according to claim 15, wherein the third region is a region outside the viewing angle of the photographing apparatus before the photographing apparatus rotates along the first to-be-changed-to direction based on the control command.

17. A method for controlling a photographing system, wherein the photographing system comprises:
a ranging sensor to measure distances of each to-be-photographed objects associated with each of a plurality of regions, wherein the plurality of to-be-photographed objects include a first target object, the first target object is associated with a first region and a first distance; and
a photographing apparatus to perform focus control based on the distances,
wherein the control method comprises:
causing the photographing apparatus to perform focus control on the first target object based on the first distance,
controlling the photographing apparatus to obtain a plurality of images,
determining, based on the plurality of images, whether a second target object is in the first region, the second target object being a moving object in the first region, and
causing the photographing apparatus to perform different focus controls on the first region based on whether or not the second target object is present in the first region.

18. The method according to claim 17, wherein the causing the photographing apparatus to perform different focus controls on the first region based on whether or not the second target object is present in the first region further including:
after determining that the second target object does not exist in the first region, causing the photographing apparatus to perform the focus control on the first target object based on a second distance measured by the ranging sensor.

19. The method according to claim 17, wherein the causing the photographing apparatus to perform different focus controls on the first region based on whether or not the second target object is present in the first region further including:
after determining that the second to-be-photographed object exists in the first region, prohibiting the photographing apparatus from performing the focus control on the first target object based on a second distance measured by the ranging sensor.

20. The method according to claim 17, including:
deriving an optical flow associated with the first region based on the plurality of images obtained by the photographing apparatus, and
determining whether the second target object exists in the first region based on the optical flow.
